(19) United States
(12) Patent Application Publication
(10) Pub. No.: US 2011/0281105 A1
(43) Pub. Date: Nov. 17, 2011

(54) NANOSTRUCTURED ANTICORROSION COATING, STRUCTURE INCLUDING SAME AND METHOD FOR ANTICORROSION PROTECTION OF A SUBSTRATE

(75) Inventors: Elisa Campazzi, Boulogne Billancourt (FR); Alain Jonas, Louvain-La-Neuve (BE); Bernard Nysten, Sauveniere (BE); Cedric Burhin, Bruxelles (BE)

(73) Assignees: Universite Catholique De Louvain, Louvain-La-Neuve (BE); Euro. Aeronautic Defence and Space Co. Eads France, Paris (FR)

(21) Appl. No.: 12/812,462

(22) PCT Filed: Jan. 8, 2009
(86) PCT No.: PCT/FR2009/050022

§ 371 Date: Nov. 2, 2010

(30) Foreign Application Priority Data
Jan. 14, 2008 (FR) 0850196

(51) Int. Cl. C09D 5/08; B32B 5/16; B32B 15/04; B05D 3/04; B05D 1/36; B05D 3/02; B32B 9/00; B05D 3/00; B82Y 30/00

(52) U.S. Cl. 428/328; 428/702; 428/688; 428/469; 428/689; 428/532; 427/402; 427/352; 977/773

(57) ABSTRACT

The invention relates to a polyelectrolyte-based nanostructured anticorrosion coating, comprising at least one main compartment which comprises:
a polyelectrolyte multilayer (1) doped with at least one anticorrosion agent (4), and
an upper multilayer (2a) acting as a barrier to the diffusion of the dopants, and whose upper surface corresponds to the upper surface of the main compartment,
   and optionally one or more secondary compartments, each comprising:
a polyelectrolyte multilayer (8; 11) doped with at least one functional agent other than an anticorrosion agent, and
an upper multilayer (2b; 2c) acting as a barrier to the diffusion of the dopants, and whose upper surface corresponds to the upper surface of the secondary compartment.

The invention also relates to a structure comprising a metallic substrate and such a coating, and also to its use in the aeronautical or aerospace field and to the process for preparing it.

The present invention relates to a nanostructured anticorrosion coating and to a structure comprising it, which are intended to be used in aeronautical and aerospace applications, and to a process for the anticorrosion protection of a metallic or non-metallic substrate.

In the aeronautical field, protection against corrosion is generally obtained by means of chromium VI-based coatings deposited, for example, by anionic bath oxidation.

However, several studies have shown the harmfulness of chromium VI, especially its toxicity, its carcinogenic nature and its environmental toxicity.

Replacing hexavalent chromium salts in formulations and obtaining products that can keep the same characteristics and performances for the produced layers are a major challenge for the aeronautics industry.

There is thus a need to find another system for protecting against corrosion, which is at least as efficient as the existing systems, and which has no toxicity.

Several technical replacement solutions exist, among which mention may be made of the “layer-by-layer” or “lbl” deposition technique.

International patent application WO 03/014 234 describes a protective coating obtained via this technique, using polyelectrolyte solutions. The layers may be deposited either by alternately using solutions of anionic polyelectrolyte and of cationic polyelectrolyte, or by using a solution comprising anionic and cationic polyelectrolytes.

This coating may also contain additives, especially to improve the abrasion resistance.

However, the co-adsorbed inorganic reinforcer serves only as a mechanical reinforcement and does not have any active anticorrosion role.

Document US 2003/0 027 011 discloses an article comprising a metallic substrate and an anticorrosion coating that comprises alternating layers of organic and inorganic species, deposited via the lbl technique. This coating also comprises a corrosion inhibitor or anticorrosion agent.

However, the anticorrosion agent is incorporated a posteriori into the layer, which is time-consuming and does not make it possible to consider the easy creation of multicompartment and multifunctional films.

The Applicant has discovered that the use of a multilayer of polyelectrolyte(s) doped with at least one anticorrosion agent combined with a particular barrier multilayer makes it possible to improve the corrosion resistance of substrates, which are preferably metallic. This multilayer doped with at least one anticorrosion agent and delimited by this barrier multilayer constitutes a main compartment.

These polyelectrolyte-based multilayers are deposited according to the lbl technique, for example by dip-coating, deposition onto a spinning substrate (or spin-coating), sprinkling, spraying, laminar coating and brush coating, and make it possible to obtain uniform, covering, defect-free films, whose thickness is generally between 1 and 100 nm, which may be up to several micrometers under certain deposition conditions. This technique allows fine control of the thickness of the deposited layers.

In addition, the compounds used to obtain such films are of reduced toxicity and are easy to use. These compounds have the additional advantage of being compatible with environmental regulations, and especially of being used predominantly in aqueous medium.

Furthermore, a coating comprising such a main compartment may also comprise at least one other functional agent different than an anticorrosion agent, or alternatively at least one other compartment known as a “secondary compartment”, in which the anticorrosion agent is replaced with another functional agent. This makes it possible to obtain a coating with only one or several compartments, which is polyfunctional, i.e. which may have properties other than corrosion resistance, such as mechanical strength, scratch resistance and friction resistance, color, a hydrophobic nature, biocompatibility and/or a bactericidal nature, while at the same time showing good adherence to a metallic substrate.

These coatings thus allow the coexistence of several different functionalities.

For the purposes of the present invention, the term “functional agent” means an agent that gives a property such as corrosion resistance, mechanical strength, scratch resistance, friction resistance, coloration, a hydrophobic nature, biocompatibility and/or a bactericidal nature.

One subject of the present invention is thus a polyelectrolyte-based nanostructured anticorrosion coating, comprising at least one main compartment which comprises:
a polyelectrolyte multilayer doped with at least one anticorrosion agent, and
an upper multilayer serving as a barrier to the diffusion of doping agents, and whose upper surface corresponds to the upper surface of the main compartment.

The term “nanostructured coating” means a coating whose structure is controlled at the nanometric scale. This structure may especially be confirmed by X-ray reflectometry and small-angle X-ray scattering, transmission microscopy (or TEM) or atomic-force microscopy (or AFM).

For the purposes of the present invention, the term “dopant” means a chemical species that is in minor amount relative to the polyelectrolyte(s) forming the doped multilayer. The dopant makes it possible especially to give the doped multilayer a particular property. The dopant(s) in the main compartment is (are) the anticorrosion agent(s), and optionally any functional agent other than an anticorrosion agent as described hereinbelow. In the secondary compartment(s), the dopant(s) is (are) any functional agent other than an anticorrosion agent as described hereinbelow.

Preferably, at least one of the anticorrosion agents is in the form of nanoparticles of a metal oxide or of a metal salt, even more preferentially of a metal oxide, having, for example, a size ranging from 1 to 50 nm and better still from 2 to 10 nm, as measured by TEM.

Examples of nanoparticles that may especially be mentioned include nanoparticles of cerium oxide, manganese oxide, cobalt oxide, phosphate oxide, zinc oxide, molybdenum oxide or vanadium oxide, or of rare-earth metal salts such as Ce, Nd, Pr, La or Sm, or mixtures thereof.

Other anticorrosion agents may be added by simple coadsorption, such as organic agents, for instance sodium sebacate, potassium phthalate, hydroxyapatite, sodium benzoate, sodium acetate, hydoxyquinoline, methylphenothiazine, azoles, for instance benzotriazole or tolylazole, or tetrachloro-p-benzoquinone (or chloranil).

The multilayer of polyelectrolyte(s) doped with at least one anticorrosion agent comprises an anionic polyelectrolyte or a cationic polyelectrolyte, or alternatively an alternation of layers of anionic and cationic polyelectrolytes.

For example, this polyelectrolyte multilayer doped with at least one anticorrosion agent may be prepared by successive deposition of a cationic (or anionic) polyelectrolyte and of an anticorrosion agent in the form of negatively (or positively) charged metal oxide nanoparticles.

Another example consists in codepositing the anticorrosion agent at the same time as the anionic or cationic polyelectrolytes.

The alternating deposition of a cationic poly-electrolyte and an anionic polyelectrolyte at the same time as nanoparticles acting as corrosion inhibitor has the advantage of allowing the dispersion of neutral or positively or negatively charged nanoparticles. Such an embodiment also has the advantage of allowing crosslinking of the cationic polyelectrolyte and of the anionic polyelectrolyte, in the presence of a crosslinking agent. A layer thus crosslinked makes it possible, inter alia, to limit the mobility of the trapped nanoparticles.

Preferably, the polyelectrolyte multilayer doped with at least one anticorrosion agent comprises a cationic polyelectrolyte.

In one embodiment of the invention, the main compartment may also comprise a lower layer acting as a barrier to the diffusion of doped species and whose lower surface corresponds to the lower surface of the compartment.

The main compartment may also comprise at least one functional agent other than an anticorrosion agent. This or these other functional agents may be contained in the same multilayer as the anticorrosion agent or they may be contained in one or more other multilayers of polyelectrolyte, or alternatively these two cases are possible in the same coating.

A functional agent other than an anticorrosion agent, used in the coating according to the invention, is an agent that gives the compartment a property that is different from corrosion resistance, for instance scratch resistance and friction resistance, mechanical strength, a hydrophobic nature, a color or a bactericidal effect.

As examples of functional agents that give scratch resistance and friction resistance and/or mechanical strength to the layer, mention may be made especially of titanium or aluminum alkoxides, silica or alumina nanoparticles, titanium or zirconium oxides, exfoliated clay platelets or leaflets, carbon nanotubes or inorganic or ceramic nanoparticles.

As examples of functional agents that give a hydrophobic nature, mention may be made especially of zirconium oxides and fluorinated polymers or copolymers.

As examples of functional agents that give a color, mention may be made especially of pigments or organic or inorganic dyes, such as Nile blue, coumarins, fluoresceins, phthalocyanins or pyrenes.

Examples of bactericidal agents that may especially be mentioned include antibacterial peptides and metal salts, for instance silver salts.

The nanostructured anticorrosion coating according to the invention may also comprise one or more secondary compartments, each comprising:
a polyelectrolyte multilayer doped with at least one functional agent other than an anticorrosion agent, such as those mentioned hereinabove, and
an upper multilayer acting as a barrier to the diffusion of the dopants, and whose upper surface corresponds to the upper surface of the secondary compartment.

The multilayers acting as barrier to the diffusion of the dopants described above preferably comprise an anionic polyelectrolyte and a cationic polyelectrolyte, that are crosslinked. A preferential method consists in using polyacids and polyamines, and in crosslinking them to form amide bonds.

These barrier multilayers make it possible to virtually completely limit, or even completely limit, the diffusion of the dopants between the main and secondary functional compartments, and between the secondary compartments.

Various ways exist for crosslinking polyelectrolyte multilayers, for example thermally, or in the presence of one or more crosslinking agents. The crosslinking may be performed in the presence of a crosslinking agent chosen as a function of the chemical nature of the polyelectrolytes, for example an amidation agent such as 1-ethyl-3-dimethylaminopropylcarbodiimide and N-hydroxysuccinimide in the case of poly(acrylic acid) and poly(allylamine). Other examples of crosslinking agents are etherification agents, for instance acetonitrile or N,N-dimethylformamide, or imidation agents, for instance 2-pyridone or 2-oxazoline.

The barrier multilayer is made by alternating deposition of a cationic polyelectrolyte and an anionic polyelectrolyte in the presence of one or more crosslinking agents.

As examples of cationic polyelectrolytes that may be used in the coating of the invention, mention may be made of polymers containing amine groups, for instance a poly(allylamine hydrochloride), a poly(ethyleneimine) or chitosan; polymers containing quaternary ammonium groups such as a poly(diallyldimethylammonium chloride) and a poly(vinylbenzyltrimethylammonium chloride); and polymers containing pyridine or pyridinium groups, for instance a poly(N-methylvinylpyridine).

As examples of anionic polyelectrolytes that may be used in the coating of the invention, mention may be made of polyacids such as a poly(acrylic acid) or a poly(methacrylic acid); polymers containing sulfonate groups, for instance a poly(styrene sulfonate), a poly(vinyl sulfonate) or a sulfonated poly(ether ether ketone); polymers containing sulfate groups, in particular a poly(vinyl sulfate); polymers containing phosphonate or phosphate groups; and anionic polysaccharides.

The anticorrosion coating may also comprise a layer that promotes the adhesion of a subsequent surface treatment. This layer is preferably based on a polyelectrolyte, for instance one of those mentioned hereinabove.

For the purposes of the present invention, the term “subsequent surface treatment” means a primary layer of paint, formed from a charged organic matrix, which is generally epoxy-based. The primary layer of paint is generally protected by the finishing paint, based on epoxy or polyurethane. This last coat especially provides a physical barrier to environmental attack, extreme weather conditions, UV and various pollutants, and decoration.

Furthermore, the presence of a multilayer coating underlying the subsequent surface treatment layer will make it possible to reinforce in particular the overall corrosion-protecting properties.

The coating as described above is preferably used for improving the corrosion resistance, scratch resistance, friction resistance, mechanical strength, hydrophobic nature and/or color of a substrate in the aeronautical or aerospace field.

Another subject of the invention is a structure comprising:
a substrate, and
a nanostructured anticorrosion coating based on polyelectrolytes as defined above.

The substrate may be metallic or non-metallic.

The metallic substrate that may be used in the present invention is preferably made of aluminum or an alloy thereof, for instance aluminum of the family 2000, more particularly plated or unplated Al 2024, aluminum of the family 7000, and even more particularly Al 7075 or 7175 and aluminum of the family 6000 or 5000, or made of titanium or magnesium.

As examples of non-metallic substrates, mention may be made especially of composite substrates, such as plastics reinforced with carbon fibers (or “carbon fiber reinforced plastics” (CFRP)), for instance thermosetting plastics or thermoplastics.

In the context of aeronautical structures composed of several materials, the coating as described in the present invention is compatible with all the substrates mentioned hereinabove. For example, it will give these substrates reinforcement of the substrate/primary paint interface.

The structure may also comprise a layer for adhesion to the substrate, based on polyelectrolyte, between the substrate and the anticorrosion coating. The adhesion to the substrate takes place not only via the electrostatic interactions, but may also take place via chemical interactions, for instance organometallic complex bonding with the substrate. This substrate-adhesion layer may comprise a cationic or anionic polyelectrolyte chosen, for example, from those defined hereinabove, and preferably chosen from anionic polyelectrolytes and better still a poly(acrylic acid).

Another subject of the invention is the use of the coating according to the invention for improving the corrosion resistance, scratch resistance, friction resistance, mechanical strength, hydrophobic nature and/or color of a metallic or non-metallic substrate, in the aeronautical or aerospace field.

A subject of the invention is also a process for preparing a structure as defined above. This preparation process comprises steps for preparing a main compartment, during which:
(a) a polyelectrolyte multilayer doped with at least one anticorrosion agent is deposited on a substrate, according to the layer-by-layer technique, and
(b) an upper multilayer acting as a barrier to the diffusion of the dopants is deposited, according to the layer-by-layer technique.

The process according to the invention may also comprise a step before step (a), during which a layer for adhesion to the substrate is deposited.

In this process, it is also possible to dope with at least one functional agent, other than an anticorrosion agent, the polyelectrolyte multilayer doped with at least one anticorrosion agent, for example by coadsorption.

The process according to the invention may also comprise steps for preparing a secondary compartment, during which:
(c) a multilayer doped with at least one functional agent other than an anticorrosion agent is deposited on a barrier multilayer prepared, for example, in step (b) or (d), according to the layer-by-layer technique, and
(d) an upper multilayer acting as a barrier to the diffusion of the dopants is deposited, according to the layer-by-layer technique,

these two steps (c) and (d) being repeated one or more times, i.e. as many times as there are additional functionalities to be given to the layer.

The process according to the invention may also comprise a step during which a layer that promotes the adhesion of a subsequent surface treatment is deposited.

In this process for preparing a structure as defined hereinabove, each multilayer is deposited by means of the process comprising the following steps, which consist in:
(i) preparing:
   a first aqueous solution or a solution containing one or more polar solvents such as ethanol, isopropanol or dimethyl sulfoxide, preferably an aqueous solution, the first solution comprising a poly-electrolyte, and
   a second aqueous solution or solution containing one or more polar solvents such as ethanol, isopropanol or dimethyl sulfoxide, preferably an aqueous solution, the second solution comprising at least one dopant of opposite charge to that of the polyelectrolyte of the first solution, a polyelectrolyte of opposite charge to that of the polyelectrolyte of the first solution, or a mixture thereof,
(ii) adsorbing a layer of the first solution prepared in step (i) onto the surface to be covered,
(iii) rinsing the surface in the solvent used for the first solution so as to remove the excess of first solution,
(iv) drying the layer, especially thermally, with a stream of neutral gas such as filtered compressed air or nitrogen, or by combining the two techniques,
(v) deposing a second solution prepared in step (i),
(vi) rinsing in the solvent used for the second solution so as to remove the excess of second solution,
(vii) drying, especially thermally, with a stream of neutral gas such as filtered compressed air or nitrogen, or by combining the two techniques,
(viii) repeating steps (ii) to (vii), and
(ix) optionally performing steps (ii) to (iv) a final time, until the desired thickness is obtained.

Preferably, steps (ii) to (vii) (step (viii)) are repeated from 1 to 20 times, better still from 1 to 10 times and even more particularly form 5 to 10 times. This repetition and the optional final implementation of steps (ii) to (iv) (step (ix)) make it possible to obtain a multilayer thickness preferably ranging from 2 to 100 nm and better still from 2 to 50 nm.

Steps (ii), (iii), (v) and (vi) described above are especially performed by dipping-removal, spraying, sprinkling or deposition on a spinning substrate.

The concentrations of polyelectrolyte(s) in the solutions prepared in step (i), expressed as monomers, may be within the range preferably from 10⁻³ to 5×10⁻² mol/l (or M).

The concentrations of dopant(s) optionally present in the second solution prepared in step (i) may be in the range preferably from 10 to 50 g/l and better still from 30 to 40 g/l.

Preferably, the layer for adhering to the substrate and the layer that promotes the adhesion of a subsequent surface treatment are deposited according to steps (i) to (iv) as defined above. They preferably have a thickness preferably ranging from 1 to 20 nm and better still from 1 to 10 nm.

Other aims, characteristics and advantages will emerge on reading the following description, which is given solely as a nonlimiting example and made with reference to the attached drawings, in which:

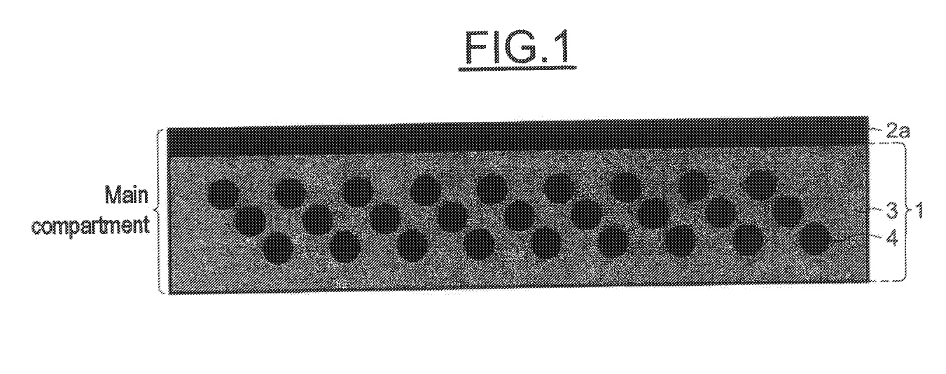

FIG. 1 illustrates one embodiment of a nanostructured anticorrosion coating according to the invention,

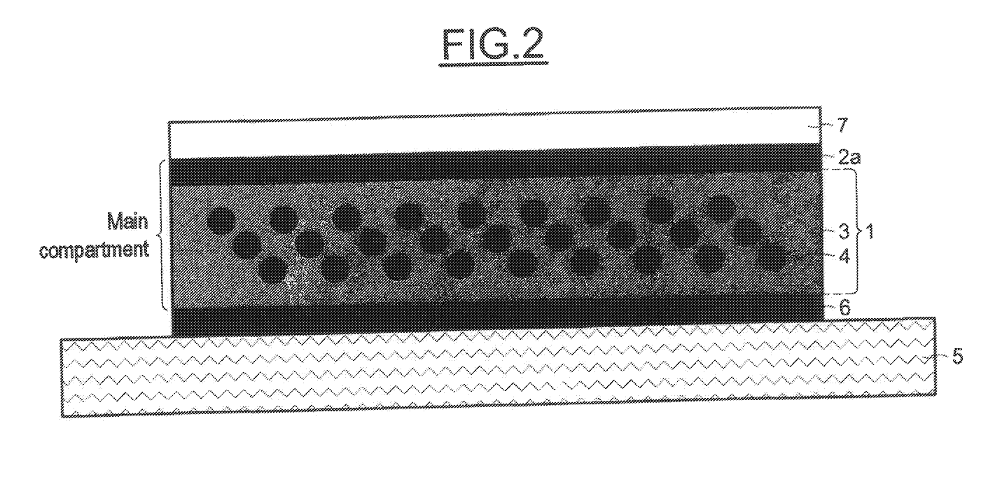

FIG. 2 illustrates an embodiment of a nanostructured anticorrosion coating deposited on a metallic substrate, and

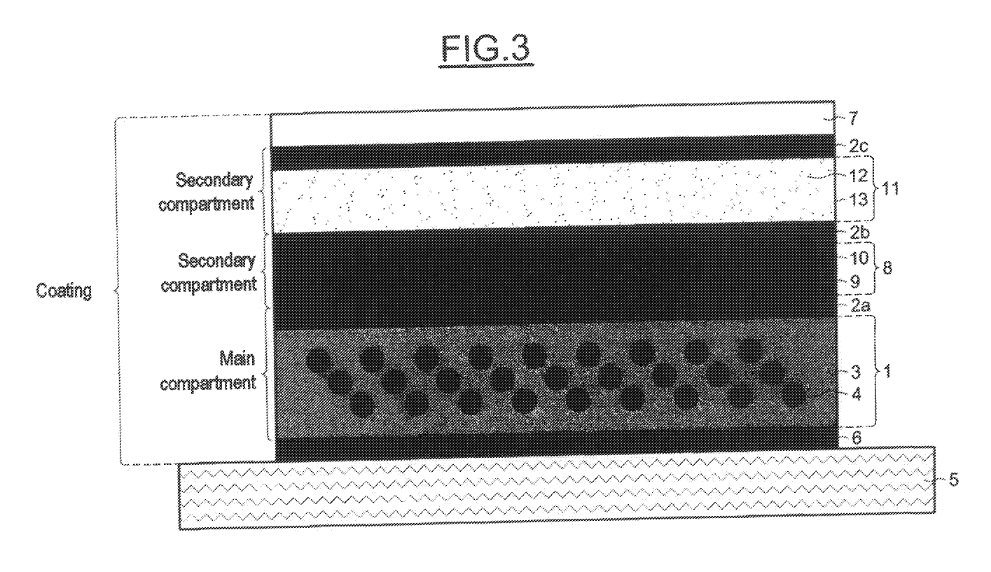

FIG. 3 illustrates an embodiment of a structure according to the invention.

A polyelectrolyte-based nanostructured anticorrosion coating may be formed by the repetition of an elementary unit, known as the main compartment. As illustrated in FIG. 1, the main compartment comprises a multilayer 1 doped with anticorrosion agents and a multilayer 2a that is a barrier to the diffusion of the anticorrosion agents.

The multilayer 1 doped with anticorrosion agent comprises a polyelectrolyte matrix 3 in which is trapped an anticorrosion agent 4 in the form of nanoparticles preferably having a size ranging from 1 to 50 nm and better still from 2 to 10 nm. The anticorrosion agent 4 in this case is the dopant.

For example, this multilayer 1 of polyelectrolyte doped with at least one anticorrosion agent may be prepared by successive deposition of a cationic polyelectrolyte such as a poly(allylamine hydrochloride) and of an anticorrosion agent in the form of negatively charged metal oxide nanoparticles.

The multilayer 2a that is a barrier to the diffusion of the dopants comprises crosslinked polyelectrolytes.

The multilayer 2a that is a barrier to the diffusion of the dopants is generally prepared by alternating deposition of a cationic polyelectrolyte and an anionic polyelectrolyte in the presence of a crosslinking agent. The crosslinking agent makes it possible to create bridges maintained by covalent bonds between the chains of two polyelectrolytes of opposite charge. This layer leads to the production of a compartment of reduced permeability. Such a multilayer 2a makes it possible to limit the diffusion of the nanoparticles of the anticorrosion multilayer toward the other functional multilayers.

The crosslinking agent(s) are either coadsorbed during all the deposition steps, or during some of them. The diffusion-barrier layer may be made by alternating, for example, the deposition of a poly(acrylic acid) (PAA) and a poly(allylamine hydrochloride) (PAH) in the presence of crosslinking agent(s) such as 1-ethyl-3-dimethylaminopropylcarbodiimide (EDC) or N-hydroxy-succinimide (NHS).

This nanostructured anticorrosion coating may be deposited onto a metallic substrate. It is then desirable to promote good interfaces, firstly between the nanostructured anticorrosion coating and the substrate, and secondly between the nanostructured anticorrosion coating and the subsequent treatment layers. This is illustrated in FIG. 2.

To do this, an adhesion layer 6 between the substrate 5 and the nanostructured anticorrosion coating according to the invention is intercalated.

The upper face of said adhesion layer 6 has properties that are compatible with the development of the nanostructured anticorrosion coating. The lower face of said adhesion layer 6 forms bonds with the surface atoms of the substrate 5. Said bonds are generally of electrostatic or complexation type. It should be noted that, depending on the chemical nature of the substrate 5 and of the polyelectrolyte used for the formation of the adhesion layer 6, bonding by organometallic complexing with the pendent atoms of the surface of the substrate may be obtained. In this case, the interaction between the adhesion layer 6 and the substrate 5 is better. For example, the layer 6 is formed from an anionic polyelectrolyte, for instance a poly (acrylic acid) (PAA).

The protection of a substrate, for example a metallic substrate, is generally followed by other processes, for example a painting process. In order to ensure the compatibility of the nanostructured anticorrosion coating with such subsequent treatments, a layer 7 that promotes the adhesion of subsequent treatment layers is deposited on the upper face of the nanostructured anticorrosion coating.

The upper face of the layer 7 that promotes the adhesion of subsequent treatment layers may be adapted so as to have properties that promote the deposition of the subsequent treatment layers. It may thus have, for example, a hydrophobic or hydrophilic nature, chemical affinity, a polar or protic nature, particular chemical groups promoting polymerization or crosslinking, hardness or mechanical strength properties. The layer 7 may comprise adaptive polymers, i.e. polymers that exhibit a predefined response as a function of an environmental stress, for instance a variation in pH, temperature, ionic strength or luminosity. The layer 7 thus obtained reacts to a given medium and changes its morphological characteristics or releases its dopant in a controlled manner. Such adaptive polymers are especially described in S. A. Sukhishvili, Curr. Opin. Coll. Interf. Sci. 2005, 10, 37-44. Examples that may especially be mentioned include polyamines and polyacids that are pH-sensitive; copolymers containing polyelectrolyte blocks and heat-responsive blocks, for instance poly(isopropylacrylamide), polysaccharides, for instance carrageenans, or poly(diethylene glycol methyl ether methacrylate), or alternatively poly(methyl vinyl ether).

FIG. 3 illustrates another embodiment in which the nanostructured anticorrosion coating comprises, in addition to the main compartment, two secondary compartments. A first secondary compartment comprises the multilayers 8 and 2b, and the second secondary compartment comprises the multilayers 11 and 2c.

In this case, the adhesion-promoting layer 7 is deposited onto the final barrier layer, in this case the layer 2c.

Each secondary compartment comprises at least one functional layer. The term “functional layer” means a layer that has noteworthy chemical, physical or biological properties. It may be, purely by way of example, chemical affinity, hydrophobicity, hardness, mechanical strength, biocompatibility properties or bactericidal properties.

In FIG. 3, the mechanical reinforcing multilayer 8 comprises a matrix 10 of polyelectrolyte incorporating exfoliated clay leaflets 9. In such a multilayer, the mechanical strength properties of the exfoliated clay leaflets 9 are imparted to the whole mechanical reinforcing multilayer 8 via the polyelectrolyte matrix 10. Another functional agent that imparts mechanical reinforcement, for example carbon nanotubes or ceramic nanoparticles, may be used.

The mechanical reinforcing multilayer 8 may be made, for example, by alternating the deposition of a cationic polyelectrolyte, such as a PAH, and that of exfoliated clay leaflets, for example montmorillonite, or another charged exfoliable inorganic compound that has suitable mechanical properties.

The structure of FIG. 3 comprises another functional multilayer that is a coloring multilayer 11. Such a polyelectrolyte matrix 13 incorporates pigments 12, which may be organic or inorganic, in the form of nanoparticles.

The coloring multilayer 11 may be made by alternating the deposition of a cationic polyelectrolyte, such a PAH, and an anionic polyelectrolyte, such as PAA. Depending on the nature of the colored pigment, it will be coadsorbed with the polyelectrolytes or will be introduced by diffusion into the formed multilayer. The colored pigment will be in the form, for example, of nanoparticles and will be, for example, Nile blue, charged coumarins, fluoresceins, phthalocyanins, pyrenes, organic or inorganic nanoparticles, whose color depends on their size.

The various compartments are separated by diffusion-barrier multilayers 2a, 2b and 2c that limit the migration of a dopant from one multilayer to another. Among the dopants present in this embodiment, mention may be made of anticorrosion agents, mechanical reinforcing agents and pigments.

The multilayers are developed according to the layer-by-layer (lbl) technique. A multilayer comprises at least one matrix and may comprise one or more functional agents.

The process for preparing a structure according to the invention consists in depositing onto a substrate several multilayers that each have a distinct functional role. Each multilayer is itself made by performing a deposition process of layer-by-layer type, comprising steps (i) to (ix) as described hereinabove.

The process for preparing a structure according to the invention comprises a succession of steps during which the deposition process described previously is performed with different first and second deposition solutions that depend on the properties of the layers to be made.

In one embodiment of the invention, illustrated in FIG. 3, the multilayer structure is made on a substrate 5, for example made of aluminum, via the process described previously.

The adhesion layer 6 is a layer of polyelectrolyte (anionic or cationic) that ensures good adhesion to the substrate 5. The adhesion is promoted on the one hand via the electrostatic interactions, and on the other hand via chemical interactions. For example, a layer of poly(acrylic acid) (PAA) may form a complex with native aluminum oxides. The layer 6 is deposited from a solution of polyelectrolyte, according to steps (i), (ii), (iii) and (iv) described previously.

The multilayer 1 doped with anticorrosion agent is made by successive deposition of a cationic polyelectrolyte such as poly(allylamine hydrochloride) (PAH) and of an anticorrosion agent 4. The anticorrosion agent may be in the form of negatively charged metal oxide nanoparticles, for example CeO₂. The deposition of the multilayer 1 doped with anticorrosion agent is performed by carrying out the following steps:
(i′) a first solution (I) of a first poly-electrolyte, a second solution (II) of anticorrosion agent of charge opposite that of the first polyelectrolyte or a second solution (II′) comprising the mixture of a second polyelectrolyte of charge opposite that of the first polyelectrolyte and of anticorrosion agent is prepared,
(ii′) a layer of solution (I) prepared in step (i′) is adsorbed onto the adhesion layer 6, for example by dipping-removal of the covered substrate,
(iii′) the surface is rinsed in the solvent used for the solution (I) so as to remove the excess of solution (I),
(iv′) the layer is dried,
(v′) solution (II) or (II′) prepared in step (i′) is deposited, for example by dipping-removal,
(vi′) rinsing is performed in the solvent used for solution (II) or (II′) so as to remove the excess of solution (II) or (II′),
(vii′) drying is performed,
(viii′) steps (ii′) to (vii′) are repeated n times, and
(ix′) a final layer is deposited with the solution (I) by carrying out steps (ii′), (iii′) and (iv′).

A thickness of polyelectrolyte multilayer 1 doped with anticorrosion agent ranging most particularly from 10 to 100 nm and better still from 10 to 50 nm is preferably obtained. Steps (ii′) to (vii′) are repeated n times, n ranging in particular from 5 to 20, better still from 5 to 10 and even more preferentially n is equal to 10.

For example, the first solution (I) may be an aqueous solution of cationic polyelectrolyte, for instance poly(allylamine hydrochloride) (PAH) and the second solution may be an aqueous solution (II) of negatively charged metal oxide nanoparticles or a solution (II′) of these same nanoparticles combined with an anionic polyelectrolyte such as PAA.

Other water-dispersible anticorrosion agents may also be added by simple coadsorption.

The diffusion-barrier multilayer 2a comprising crosslinked polyelectrolytes is deposited onto the multilayer 1. The multilayer 2a acts as a barrier for limiting the diffusion of the dopants between the various functional compartments.

The deposition of the multilayer 2a is performed by carrying out the following steps:
(i″) a first solution (III) of polyelectrolyte, for example of anionic polyelectrolyte such as PAA, and a second solution (IV) of polyelectrolyte of charge opposite that of the first polyelectrolyte, for example of cationic polyelectrolyte such as PAA, is prepared. The concentrations of polyelectrolytes, expressed as monomers, are preferably in the range from 10⁻³ to 5×10⁻² mol/l (or M). For example, it may be equal to 0.01 M of monomers.
(ii″) a layer of the solution (III) prepared in step (i″) is adsorbed onto the multilayer 1, for example by dipping-removal of the covered substrate,
(iii″) the surface is rinsed in the solvent used for solution (III) so as to remove the excess of solution (III),
(iv″) the layer is dried,
(v″) solution (IV) prepared in step (i″) is deposited,
(vi″) rinsing is performed in the solvent used for solution (IV) so as to remove the excess of solution (IV),
(vii″) drying is performed,
(viii″) steps (ii″) to (vii″) are repeated m times, and
(ix″) a final layer is deposited with the solution (III) by performing steps (ii″), (iii″) and (iv″).

A thickness of multilayer 2a ranging preferably from 2 to 50 nm and better still from 2 to 20 nm is preferably obtained. Steps (ii″) to (vii″) are repeated m times, m ranging in particular from 1 to 20, better still from 1 to 10 and even more preferentially m is equal to 1 to 5.

The depositions of layers are performed, for example, in the presence of the crosslinking agents 1-ethyl-3-dimethylaminopropylcarbodiimide (EDC) and N-hydroxy-succinimide (NHS). These crosslinking agents (EDC and NHS) may be added throughout all the deposition steps or only during some of them.

The mechanical reinforcing multilayer 8 for improving the mechanical strength is made by successive depositions of a cationic polyelectrolyte and of an agent that imparts mechanical reinforcement 9. The cationic polyelectrolyte is, for example, PAH and the agent that imparts mechanical reinforcement 9 may be clay leaflets 9 prepared from montmorillonite or another inorganic compound. The multilayer 8 is obtained by first preparing an aqueous solution of cationic polyelectrolyte and an aqueous solution of an agent that imparts mechanical reinforcement in step (i), followed by successively repeating p times steps (ii) to (vii) as described above and performing step (ix). The number of repetitions of steps (ii) to (vii), noted herein as p, is, for example, within the range from 5 to 20, preferably from 5 to 10 and better still p is equal to ten.

The multilayer 2b acting as a barrier for limiting the diffusion of the dopants between the various functional compartments is then deposited in the same manner as the multilayer 2a.

The coloring multilayer 11 of FIG. 3 is then prepared by successive depositions of an anionic polyelectrolyte such as PAA, and of a cationic polyelectrolyte such as PAH, in the presence of a pigment 12. The pigment 12 may be organic, for example in the form of nanoparticles. The pigment 12 is deposited by coadsorption. To deposit such a coloring multilayer 11, PAH and PAA may be used, for example, with Nile blue, charged coumarins or fluoresceins or other compounds such as those mentioned hereinabove. Depending on the nature of the colored pigment, it will be coadsorbed with the polyelectrolytes or will be introduced by diffusion into the formed multilayer.

The deposit is prepared starting from step (i), i.e. by preparing separate aqueous solutions of PAA and of PAH, followed by the succession of steps (ii) to (vii) as described above, repeated r times, and then optionally performing step (ix). The number of repetitions of steps (ii) to (vii), noted herein as r, is, for example, within the range from 5 to 20 and preferably from 5 to 10, and better still r is equal to ten.

The multilayer 2c acting as a barrier for limiting the diffusion of the dopants between the various functional compartments is then deposited in the same manner as the multilayers 2a and 2b.

The layer 7 that promotes adhesion between the multilayer 2c and an optional subsequent treatment (or “top coat”) is then deposited. Such a layer may comprise an anionic polyelectrolyte or a cationic polyelectrolyte, and more particularly a PAH and an epoxide-based varnish. The deposition is performed by successively repeating steps (ii), (iii) and (iv) as described above.

In another embodiment of the invention, the functional agents used in the development of the various layers may be combined in a single compartment. For example, the following may be deposited, using the lbl technique:
a first layer for adhesion to the substrate, the substrate being made, for example, of aluminum,
a first multilayer that is a barrier to the diffusion of the dopants,
a multilayer based on PAH and clay platelets, followed by coadsorption of a corrosion agent and a dye in a compartment,
a second multilayer that is a barrier to the diffusion of the dopants, and
a varnish-adhesion layer.

1. A polyelectrolyte-based nanostructured anticorrosion coating, comprising at least one main compartment which comprises:
a polyelectrolyte multilayer doped with at least one anticorrosion agent, and
an upper multilayer acting as a barrier to the diffusion of the dopants, and whose upper surface corresponds to the upper surface of the main compartment.

2. The anticorrosion coating as claimed in claim 1, wherein at least one anticorrosion agent is in the form of nanoparticles of a metal oxide or of a metal salt.

3. The anticorrosion coating as claimed in claim 2, wherein the nanoparticles are chosen from nanoparticles of cerium oxide, manganese oxide, cobalt oxide, phosphate oxide, zinc oxide, molybdenum oxide or vanadium oxide, or of rare-earth metal salts, or mixtures thereof.

4. The anticorrosion coating as claimed in claim 2, wherein the nanoparticles of metal oxide or of metal salt have a size ranging from 1 to 50 nm.

5. The anticorrosion coating as claimed in claim 1, wherein the polyelectrolyte multilayer doped with anticorrosion agent(s) comprises a cationic polyelectrolyte.

6. The anticorrosion coating as claimed in claim 1, wherein the polyelectrolyte multilayer doped with anticorrosion agent(s) comprises an anionic polyelectrolyte.

7. The anticorrosion coating as claimed in claim 1, wherein the polyelectrolyte multilayer doped with anticorrosion agent(s) comprises an alternation of layers of anionic and cationic polyelectrolytes.

8. The anticorrosion coating as claimed in claim 1, wherein the main compartment comprises at least one functional agent other than an anticorrosion agent.

9. The anticorrosion coating as claimed in claim 1, wherein it comprises a lower multilayer that acts as a barrier to the diffusion of the dopants, and whose lower surface corresponds to the lower surface of the compartment.

10. The anticorrosion coating as claimed in claim 1, wherein it comprises one or more secondary compartments, each comprising:
a polyelectrolyte multilayer doped with at least one functional agent other than an anticorrosion agent, and
an upper multilayer acting as a barrier to the diffusion of the dopants, and whose upper surface corresponds to the upper surface of the secondary compartment.

11. The anticorrosion coating as claimed in claim 1, wherein the multilayer acting as a barrier to the diffusion of the dopants comprises an anionic polyelectrolyte and a cationic polyelectrolyte, that are crosslinked.

12. The anticorrosion coating as claimed in claim 11, wherein the polyelectrolytes are crosslinked thermally or in the presence of one or more crosslinking agents.

13. The anticorrosion coating as claimed in claim 8, wherein the functional agent other than the anticorrosion agent gives the compartment scratch resistance, friction resistance, mechanical strength, a hydrophobic nature, a color or a bactericidal effect.

14. The anticorrosion coating as claimed in claim 13, wherein the functional agent(s) other than the anticorrosion agent are chosen from titanium or aluminum alkoxides, silica or alumina nanoparticles, titanium or zirconium oxides; exfoliated clay platelets or leaflets, carbon nanotubes or inorganic or ceramic nanoparticles; zirconium oxides, fluorinated polymers or copolymers; Nile blue, coumarins, fluoresceins, phthalocyanins and pyrenes; antibacterial peptides and metal salts.

15. The anticorrosion coating as claimed in claim 1, wherein it comprises a layer that promotes the adhesion of a subsequent surface treatment.

16. The anticorrosion coating as claimed in claim 5, wherein the cationic polyelectrolyte is chosen from polymers containing amine groups; polymers containing quaternary ammonium groups; and polymers containing pyridine or pyridinium groups.

17. The anticorrosion coating as claimed in claim 6, wherein the anionic polyelectrolyte is chosen from polyacids; polymers containing sulfonated groups; polymers containing sulfate groups and polymers containing phosphonate or phosphate groups; and anionic polysaccharides.

18. A structure comprising:
a substrate, and
a polyelectrolyte-based nanostructured anticorrosion coating as claimed in claim 1.

19. The structure as claimed in claim 18, wherein the substrate is metallic.

20. The structure as claimed in claim 19, wherein the substrate is made of aluminum or an alloy thereof, of titanium or of magnesium.

21. The structure as claimed in claim 18, wherein the substrate is a composite substrate.

22. The structure as claimed in claim 18, wherein it comprises a polyelectrolyte-based layer for adhesion to the substrate, between the substrate and the nanostructured anticorrosion coating.

23. The structure as claimed in claim 22, wherein the layer for adhesion to the substrate comprises a cationic polyelectrolyte.

24. The structure as claimed in claim 22, wherein the layer for adhesion to the substrate comprises an anionic polyelectrolyte.

25. A method for improving the corrosion resistance, scratch resistance, friction resistance, mechanical strength, hydrophobic nature and/or color of a metallic or non-metallic substrate in the aeronautical or aerospace field comprising applying a coating as claimed in claim 1.

26. A process for preparing a structure as defined by claim 18, wherein it comprises preparing a main compartment, during which:
(a) a polyelectrolyte multilayer doped with at least one anticorrosion agent is deposited on a substrate, according to the layer-by-layer technique, and
(b) an upper multilayer that acts as a barrier to the diffusion of the dopants is deposited, according to the layer-by-layer technique.

27. The process as claimed in claim 26, comprising depositing a layer for adhesion to the substrate before step (a).

28. The process as claimed in claim 26, wherein the polyelectrolyte multilayer doped with at least one anticorrosion agent is doped with at least one functional agent other than an anticorrosion agent.

29. The process as claimed in claim 26, wherein it comprises preparing a secondary compartment, during which:
(c) a multilayer doped with at least one functional agent other than an anticorrosion agent is deposited on the multilayer, according to the layer-by-layer technique, and
(d) an upper multilayer that acts as a barrier to the diffusion of the dopants is deposited according to the layer-by-layer technique,
these two steps (c) and (d) being repeated one or more times.

30. The process as claimed in claim 26, wherein a layer that promotes the adhesion of a subsequent surface treatment is deposited.

31. The process as claimed in claim 26, wherein each multilayer is deposited by means of the process comprising the following steps, which consist in:
(i) preparing:
a first aqueous solution or a solution containing one or more polar solvents, the first solution comprising a polyelectrolyte, and
a second aqueous solution or solution containing one or more polar solvents, the second solution comprising at least one dopant of opposite charge to that of the polyelectrolyte of the first solution, a polyelectrolyte of opposite charge to that of the polyelectrolyte of the first solution, or a mixture thereof,
(ii) absorbing a layer of the first solution prepared in step (i) onto the surface to be covered,
(iii) rinsing the surface in the solvent used for the first solution in order to remove the excess of first solution,
(iv) drying the layer,
(v) deposing a second solution prepared in step (i),
(vi) rinsing in the solvent used for the second solution in order to remove the excess of second solution,
(vii) thermally drying, with a stream of neutral gas,
(viii) repeating steps (ii) to (vii), and
(ix) optionally performing steps (ii) to (iv) a final time, until the desired thickness is obtained.

32. The process as claimed in claim 31, wherein steps (ii) to (vii) are repeated from 1 to 20 times.

33. The process as claimed in claim 31, wherein steps (ii), (iii), (v) and (vi) are performed by dipping-removal, spraying, sprinkling or deposition on a spinning substrate.

34. The process as claimed in claim 31, wherein the drying is performed thermally, with a stream of neutral gas, or by combining the two techniques.

35. The process as claimed in claim 34, wherein the neutral gas is filtered compressed air or nitrogen.

36. The process as claimed in claim 26, wherein the layer for adhesion to the substrate and the layer that promotes the adhesion of a subsequent surface treatment are deposited by means of the process comprising the following steps, which consist in:
(i) preparing:
a first aqueous solution or a solution containing one or more polar solvents, the first solution comprising a polyelectrolyte, and
a second aqueous solution or solution containing one or more polar solvents, the second solution comprising at least one dopant of opposite charge to that of the polyelectrolyte of the first solution, a polyelectrolyte of opposite charge to that of the polyelectrolyte of the first solution, or a mixture thereof,
(ii) absorbing a layer of the first solution prepared in step (i) onto the surface to be covered,
(iii) rinsing the surface in the solvent used for the first solution in order to remove the excess of first solution, and
(iv) drying the layer.
